(19) United States
(12) Patent Application Publication
(10) Pub. No.: US 2009/0032666 A1
(43) Pub. Date: Feb. 5, 2009

(54) Mouse pad

(76) Inventor: Chun Fu Kuo, Taichung Hsien (TW)

Correspondence Address: CHARLES E. BAXLEY, ESQUIRE, 90 JOHN STREET, SUITE 309, NEW YORK, NY, 10038, US

(21) Appl. No.: 11/888,459

(22) Filed: Jul. 31, 2007

(51) Int. Cl. B68G 5/00; A47G 29/00; A47B 91/00

(52) U.S. Cl. 248/346.01; 248/118

(57) ABSTRACT

A mouse pad includes an intermediate layer attached to a base layer, and a coating layer attached to the intermediate layer and arranged for allowing an image or pattern to be applied onto the coating layer with an image output facility by the users themselves. The mouse pad includes a release layer detachable from the base layer for protecting the base layer. A punch line is formed in an outer peripheral portion of the mouse pad for being detached or released from the base layer. The punch line of the mouse pad is preferably not formed in the release layer. The mouse pad includes a thickness for no more than 1 mm for allowing the mouse pad to be applied with the image with the image output facility.

### BACKGROUND OF THE INVENTION

1. Field of the Invention

The present invention relates to a mouse pad, and more particularly to a mouse pad including a greatly reduced or minimized thickness for allowing the mouse pad to be printed with the copy machines, printer machines, or other digital or image output facilities and thus for allowing the mouse pad to be applied with decorative patterns or words or the like thereon by the users themselves.

2. Description of the Prior Art

Typical mouse pads comprise a planar pad body for slidably or movably supporting a computer mouse, and including a pad cushion made of neoprene covered with nylon, and normally, the pad cushion includes a great thickness for resiliently or softly supporting the computer mouse.

For example, U.S. Pat. No. 5,562,270 to Montague discloses one of the typical wrist pads comprise a planar pad body including a generally rectangular shape and including a size of eight inches by nine and one-half inches that has been found to be adequate for most standard computer displays.

However, the planar pad body is made of neoprene covered with nylon that may not be applied with decorative patterns or words or the like thereon with the copy machines, printer machines, or other image output facilities, and the great thickness also prevents the planar pad body from being applied with decorative patterns or words or the like thereon with the copy machines, printer machines, or other image output facilities.

In addition, a comfortable resting pedestal for the wrist portion of the user is solidly attached to the pad body and may also prevent the planar pad body from being applied with decorative patterns or words or the like thereon with the copy machines, printer machines, or other image output facilities.

U.S. Pat. No. 5,641,369 to Kirchhoff et al. discloses another typical wrist rest assembly comprising a rectangular tray on an upper surface of which the computer keyboard or the computer mouse can be supported.

However, similarly, an enlarged and elongate pad is solidly attached to the tray for supporting the wrist portion of the user, and may also prevent the tray from being applied with decorative patterns or words or the like thereon with the copy machines, printer machines, or other image output facilities.

In addition, the tray also includes a great thickness that may prevent the tray from being applied with decorative patterns or words or the like thereon with the copy machines, printer machines, or other image output facilities.

U.S. Pat. No. 6,131,862 to Gruenenfelder discloses a further typical ergonomic support system comprising a mouse pad for selectively and movably supporting a computer mouse, and a support pad separated from the mouse pad for selectively receiving and supporting the forearm and wrist of a person operating an input-output device for a computer.

However, the mouse pad is also required to be made into a great thickness for selectively and movably supporting and engaging with the ball or the roller of the computer mouse, and the great thickness of the mouse pad may also prevent the mouse pad from being applied with decorative patterns or words or the like thereon with the copy machines, printer machines, or other image output facilities.

U.S. Pat. No. 6,402,101 to Yates discloses a still further typical foamable mouse pad comprising a relatively firm stable flat portion suitable for selectively and movably supporting a computer mouse, and a relatively soft portion for selectively receiving and supporting the forearm and wrist of a person operating an input-output device for a computer.

However, similarly, an enlarged soft portion is solidly attached to the mouse pad for supporting the wrist portion of the user, and may also prevent the mouse pad from being applied with decorative patterns or words or the like thereon with the copy machines, printer machines, or other image output facilities.

In addition, the mouse pad also includes a great thickness that may prevent the mouse pad from being applied with decorative patterns or words or the like thereon with the copy machines, printer machines, or other image output facilities.

The present invention has arisen to mitigate and/or obviate the afore-described disadvantages of the conventional mouse pads.

### SUMMARY OF THE INVENTION

The primary objective of the present invention is to provide a mouse pad including a greatly reduced or minimized thickness for allowing the mouse pad to be printed with the copy machines, printer machines, or other digital or image output facilities and thus for allowing the mouse pad to be applied with decorative patterns or words or the like thereon by the users themselves.

In accordance with one aspect of the invention, there is provided a mouse pad comprising a base layer, an intermediate layer attached to the base layer, and an outer cover or coating layer attached to the intermediate layer and arranged for allowing an image to be applied onto the coating layer with an image output facility by the users themselves.

The coating layer is preferably made of polyvinyl acetate materials or ink absorbent materials. The base layer is preferably made of rubber, plastic, polyurethane, polyvinyl chloride, polyvinyl acetate materials, or other synthetic materials.

The mouse pad includes a thickness for no more than 1 mm for allowing the mouse pad to be applied with the image with the image output facility.

The mouse pad includes a release layer attached to the base layer and detachably from the base layer for protecting the base layer.

The mouse pad includes a punch line provided in an outer peripheral portion of the mouse pad for allowing the outer peripheral portion of the mouse pad to be easily detached from the base layer. The punch line of the mouse pad is preferably not formed in the release layer.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a mouse pad in accordance with the present invention;

FIG. 2 is an exploded view of the mouse pad;

FIG. 3 is a partial cross sectional view of the mouse pad taken along lines 3-3 of FIG. 1;

FIG. 4 is a partial cross sectional view similar to FIG. 3, illustrating the application of the mouse pad;

FIG. 5 is a partial exploded view illustrating the operation of the mouse pad; and

FIG. 6 is a top plan schematic view illustrating the operation of the mouse pad.

### DETAILED DESCRIPTION OF THE PREFERRED EMBODIMENT

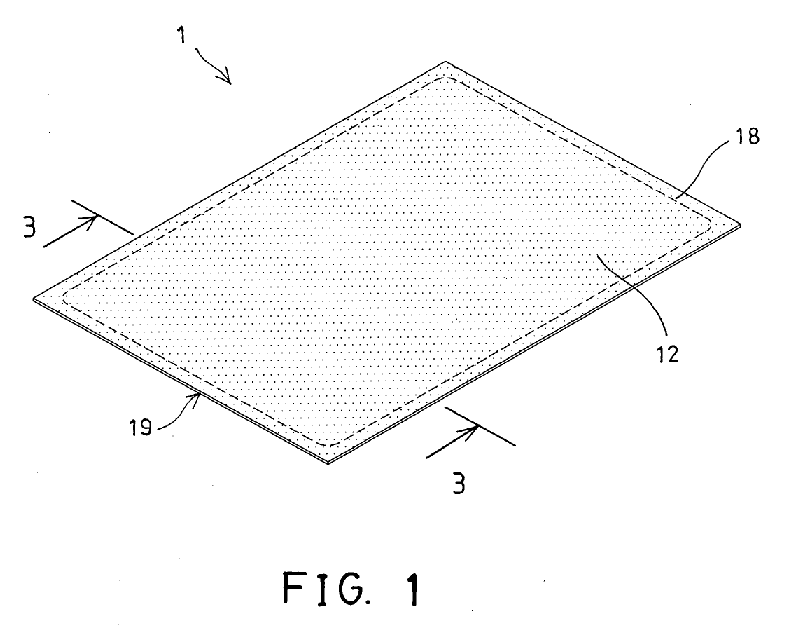

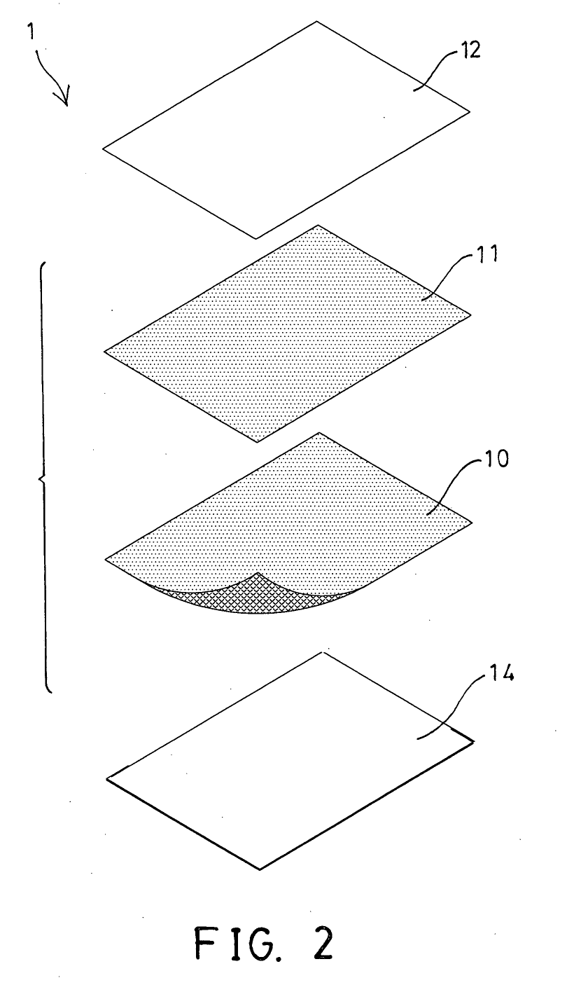

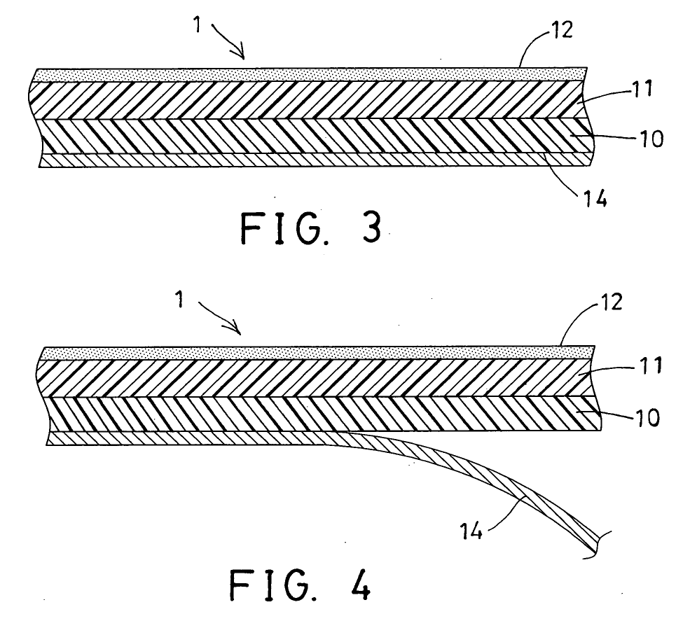

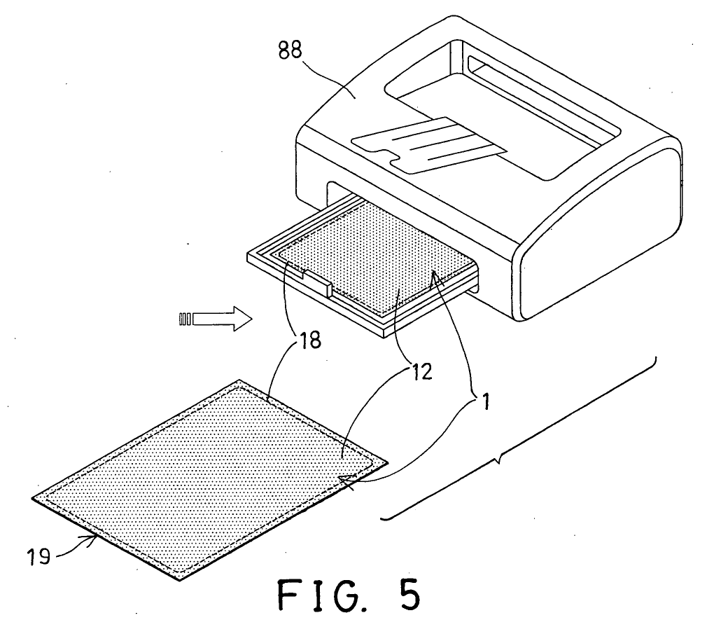

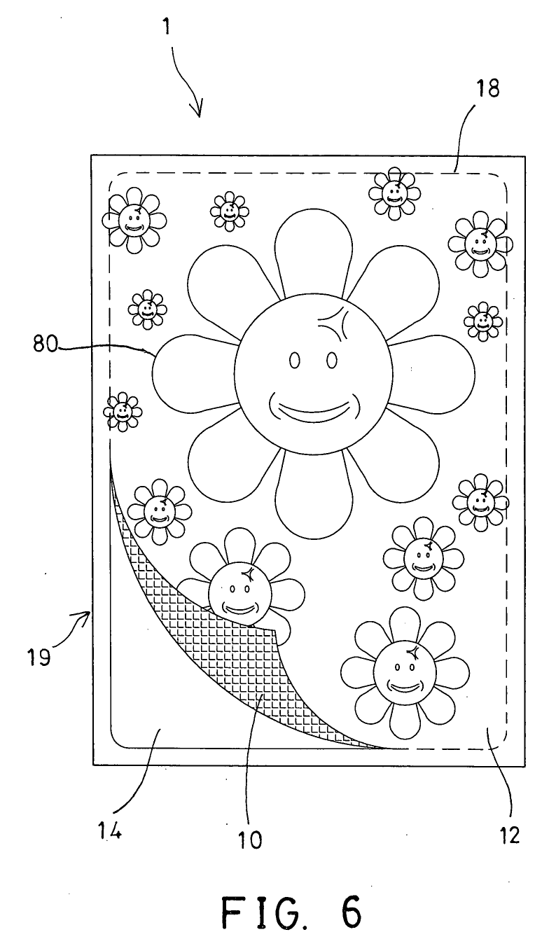

Referring to the drawings, and initially to FIGS. 1-4, a mouse pad 1 in accordance with the present invention comprises an anti-slip base layer 10 made of such as rubber, plastic, polyurethane, polyvinyl chloride, polyvinyl acetate materials, or other synthetic materials, an insert or intermediate layer 11 attached to or adhered to or secured to the base layer 10 and made of such as woven or non-woven cloth, paper, rubber, plastic, or other synthetic materials, and an outer cover or coating layer 12 attached to or adhered to or secured to the insert or intermediate layer 11 and made of such as polyvinyl acetate materials, or other synthetic materials which are water-proof, wear-proof or wear-resistive or ink absorbent materials, and on which images 80 or decorative patterns (FIG. 6) or figures or words or the like may be applied with the copy machines, printer machines, or other digital or image output facilities 88 (FIG. 5) by the users themselves.

The mouse pad 1 further includes a release layer 14 attached to or overlain on the bottom portion of the base layer 10 and releasable or detachably or disengageable from the base layer 10 (FIG. 4) by the users, for protecting the base layer 10 and for preventing the base layer 10 from being heated or dirtied or damaged by the copy machines, printer machines, or other digital or image output facilities 88 (FIG. 5). It is preferable that the release layer 14 is released or detached or disengaged from the base layer 10 (FIG. 4) by the users after the images 80 or decorative patterns or figures or words or the like have been applied onto the outer or coating layer 12 with the copy machines, printer machines, or other digital or image output facilities 88, for allowing the base layer 10 to be frictionally engaged onto the supporting tables or surfaces.

It is further preferable that the mouse pad 1 may be made or formed into various kinds of shapes and further includes a cut line or punch line 18 formed or provided on the outer peripheral edge or outer peripheral portion 19 of the mouse pad 1, without being formed in the release layer 14 for allowing the outer peripheral portion 19 of the mouse pad 1 and the release layer 14 to be easily released or detached or disengaged from the base layer 10 the insert or intermediate layer 11 and the outer or coating layer 12 (FIG. 6) by the users themselves. The mouse pad 1 is made and includes a thickness for no more than 1 mm for allowing the mouse pad 1 to be applied with images 80 or decorative patterns or words or the like thereon with the copy machines, printer machines, or other digital or image output facilities 88. The side portions or the outer peripheral portions of the images 80 or decorative patterns or words or the like may be trimmed by removing or disengaging the outer peripheral portion 19 from the mouse pad 1.

It is to be noted that the typical mouse pads failed to provide a pad member having an outer or coating layer 12 for allowing the copy machines, printer machines, or other digital or image output facilities 88 to apply decorative images 80 or patterns or figures or words or the like onto the outer or coating layer 12, and also failed to provide a pad member having a release layer 14 attached to the bottom portion of the base layer 10 and releasable or detachably or disengageable from the base layer 10 by the users, for protecting the base layer 10 and for preventing the base layer 10 from being heated or dirtied or damaged by the copy machines, printer machines, or other digital or image output facilities 88.

Accordingly, the mouse pad in accordance with the present invention includes a greatly reduced or minimized thickness for allowing the mouse pad to be printed with the copy machines, printer machines, or other digital or image output facilities and thus for allowing the mouse pad to be applied with decorative images or patterns or words or the like thereon by the users themselves.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A mouse pad comprising:
an anti-slip base layer,
an intermediate layer attached to said base layer, and
a coating layer attached to said intermediate layer and arranged for allowing an image to be applied onto said coating layer with an image output facility by the users themselves.

2. The mouse pad as claimed in claim 1, wherein said coating layer is made of ink absorbent materials.

3. The mouse pad as claimed in claim 1, wherein said base layer is made of synthetic materials.

4. The mouse pad as claimed in claim 1, wherein said mouse pad includes a thickness for no more than 1 mm for allowing said mouse pad to be applied with the image with the image output facility.

5. The mouse pad as claimed in claim 1, wherein said mouse pad includes a release layer attached to said base layer and detachably from said base layer for protecting said base layer.

6. The mouse pad as claimed in claim 5, wherein said mouse pad includes a punch line provided in an outer peripheral portion of said mouse pad for allowing said outer peripheral portion of said mouse pad to be easily detached from said base layer.

7. The mouse pad as claimed in claim 6, wherein said punch line of said mouse pad is not formed in said release layer.
